(19) United States
(12) Patent Application Publication
(10) Pub. No.: US 2025/0230828 A1
(43) Pub. Date: Jul. 17, 2025

(54) LOCK STRUCTURE

(71) Applicant: Yazaki Corporation, Tokyo (JP)

(72) Inventor: Yoshinori Takahashi, Tochigi (JP)

(21) Appl. No.: 19/014,927

(22) Filed: Jan. 9, 2025

(30) Foreign Application Priority Data
Jan. 12, 2024 (JP) 2024-003125

(51) Int. Cl. F16B 5/06; B60R 16/02; H02G 3/04

(52) U.S. Cl. CPC F16B 5/06; B60R 16/0215; H02G 3/0406

(57) ABSTRACT

A lock structure includes: a male lock portion (11) which is formed in a first structural body (10); a female lock portion (21) which is formed in a second structural body (20) and into which the male lock portion is insertable; a clearance portion which is formed adjacent to the female lock portion in the second structural body and allows for deflection of the female lock portion which occurs when the male lock portion is inserted into the female lock portion; and a restriction portion (23) which is formed in the second structural body and restricts insertion of the male lock portion into the clearance portion.

### CROSS-REFERENCE TO RELATED APPLICATION(S)

The present application claims priority to and incorporates by reference the entire contents of Japanese Patent Application No. 2024-003125 filed in Japan on Jan. 12, 2024.

### BACKGROUND OF THE INVENTION

### 1. Field of the Invention

The present invention relates to a lock structure.

### 2. Description of the Related Art

Japanese Patent Application Laid-open No. 2020-205732 discloses a technique related to a lock structure for locking a protector cover to a protector body. This lock structure includes a male lock portion having a locking piece formed to extend from the cover in an erected manner and an engagement projection protruding in a plate thickness direction of the locking piece, and a female lock portion formed on a side wall of the protector body and having an engagement portion that guides the locking piece and locks the engagement projection. The side wall includes a notch portion formed in a part of the side wall to release displacement of the locking piece due to elastic deformation of the locking piece.

Meanwhile, the lock structure of the protector or the like may have a clearance portion formed adjacent to the female lock portion to allow for deflection of the female lock portion which occurs when the male lock portion is inserted, in the case where the female lock portion and a fixed shape of a vehicle or the like are adjacent to each other. In such a configuration, there is a possibility that the male lock portion is erroneously inserted into the clearance portion.

### SUMMARY OF THE INVENTION

An object of the present invention is to provide a lock structure capable of restricting erroneous insertion of a male lock into a clearance portion.

In order to achieve the above mentioned object, a lock structure according to one aspect of the present invention includes a male lock portion which is formed in a first structural body; a female lock portion which is formed in a second structural body and into which the male lock portion is insertable; a clearance portion which is formed adjacent to the female lock portion in the second structural body and allows for deflection of the female lock portion which occurs when the male lock portion is inserted into the female lock portion; and a restriction portion which is formed in the second structural body and restricts insertion of the male lock portion into the clearance portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a lock structure according to an embodiment;

FIG. 2 is a perspective view illustrating a female lock portion of the lock structure according to the embodiment;

FIG. 3 is a cross-sectional view illustrating a cross section along a first direction of the lock structure according to the embodiment;

FIG. 4 is a cross-sectional view illustrating the cross section along the first direction of the lock structure according to the embodiment;

FIG. 5 is a perspective view illustrating a female lock portion of a lock structure according to a first modification of the embodiment;

FIG. 6 is a cross-sectional view illustrating a cross section along a first direction of the lock structure according to the first modification of the embodiment;

FIG. 7 is a perspective view illustrating a female lock portion of a lock structure according to a second modification of the embodiment;

FIG. 8 is a cross-sectional view illustrating a cross section along a first direction of the lock structure according to the second modification of the embodiment;

FIG. 9 is a perspective view illustrating a female lock portion of a lock structure according to a third modification of the embodiment; and

FIG. 10 is a cross-sectional view illustrating a cross section along a first direction of the lock structure according to the third modification of the embodiment.

### DETAILED DESCRIPTION OF THE PREFERRED EMBODIMENT

Hereinafter, a lock structure according to an embodiment of the present invention will be described in detail with reference to the drawings. Note that the present invention is not limited by the embodiment. In addition, constituent elements in the following embodiment include those that can be easily assumed by those skilled in the art or are substantially the same.

### Embodiment

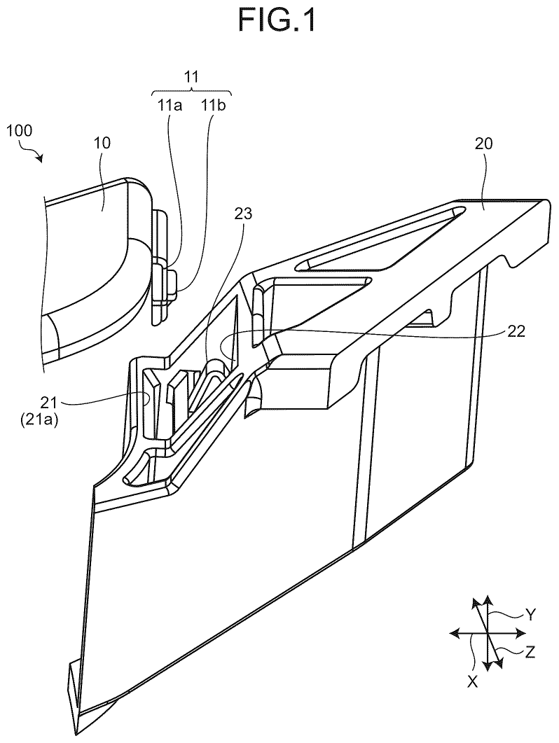

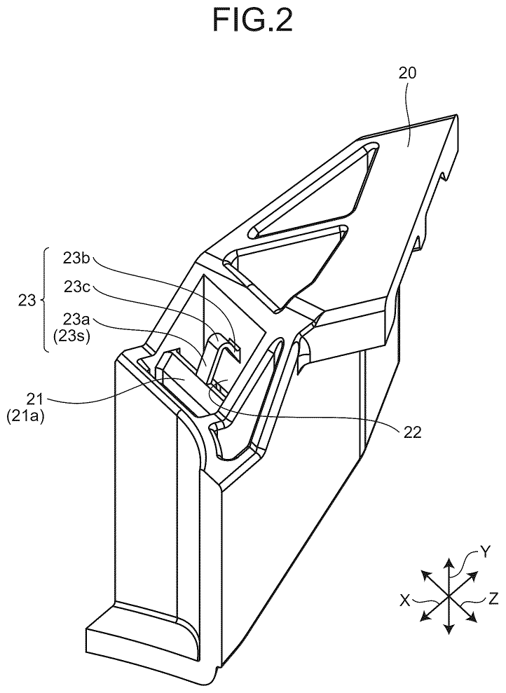

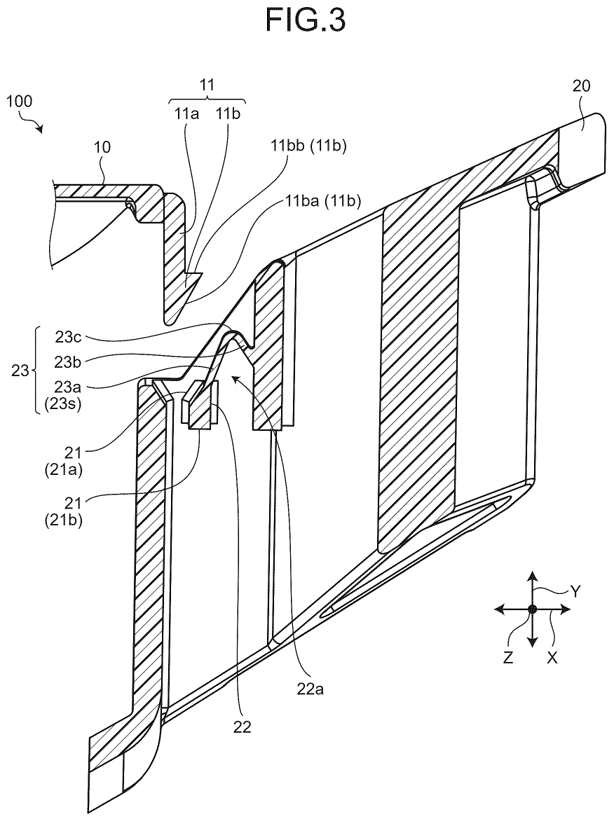

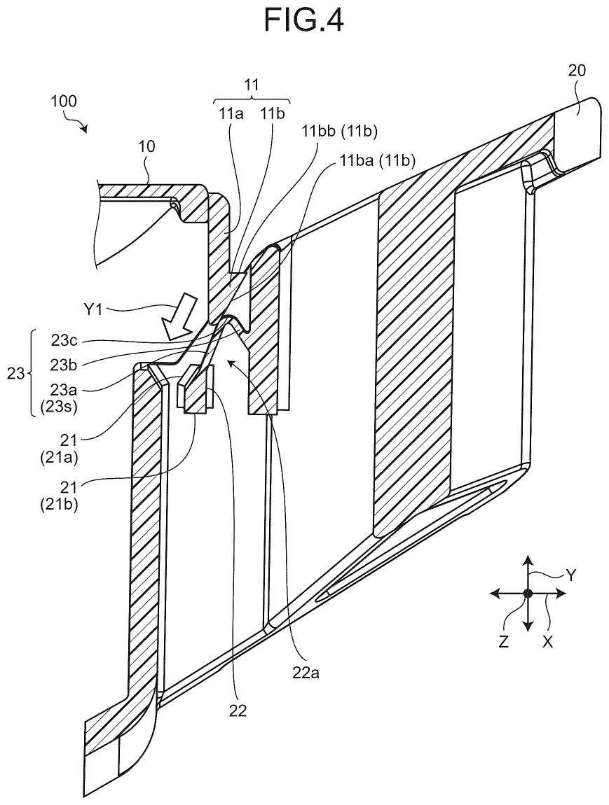

An embodiment will be described with reference to FIGS. 1 to 4. The present embodiment relates to a lock structure. FIG. 1 is a perspective view illustrating a lock structure according to an embodiment, FIG. 2 is a perspective view illustrating a female lock portion of the lock structure according to the embodiment, FIG. 3 is a cross-sectional view illustrating a cross section along a first direction of the lock structure according to the embodiment, and FIG. 4 is a cross-sectional view illustrating the cross section along the first direction of the lock structure according to the embodiment.

A lock structure 100 of the present embodiment illustrated in FIG. 1 is applied to a protector constituting a wire harness. As illustrated in FIG. 1, the lock structure 100 according to the embodiment includes a male lock portion 11, a female lock portion 21, a clearance portion 22, and a restriction portion 23. In the embodiment, the male lock portion 11 is formed in a first structural body 10 which is a lid member of the protector.

The female lock portion 21, the clearance portion 22, and the restriction portion 23 are formed in a second structural body 20 which is a base member of the protector. The lock structure 100 according to the embodiment is a structure for locking the lid member assembled to the base member to the base member. That is, the lock structure 100 is a structure in which the first structural body 10 (lid member) is locked to the second structural body 20 (base member) by engagement between the male lock portion 11 and the female lock portion 21. Here, the base member is a constituent member constituting the protector, which forms a housing space for housing wiring materials and the like. In addition, the lid member is assembled to the base member and covers the wiring materials and the like placed in the housing space of the base member.

Here, the protector is incorporated in a wire harness routed in a vehicle or the like, and is attached, for example, under the floor (for example, around the bottom of a console box) of the vehicle. In addition, the wire harness is, for example, a bundle of a plurality of wiring materials used for power supply and signal communication for connection between devices mounted on a vehicle, and the plurality of wiring materials are connected to respective devices by connectors or the like. Examples of the wiring material include a metal rod, an electric wire, a bundle of electric wires, or the like. The metal rod is formed by covering an outer side of a rod-shaped conductive member with an insulative cover.

In the following description, among a first direction, a second direction, and a third direction intersecting each other, the first direction is referred to as a “first width direction X”, the second direction is referred to as a “height direction Y”, and the third direction is referred to as a “second width direction Z”. Here, the first width direction X, the height direction Y, and the second width direction Z are orthogonal to each other. In the embodiment, the first width direction X is a direction along which the female lock portion 21 and the clearance portion 22 are adjacent to each other. The height direction Y is a direction along which the male lock portion 11 is inserted into the female lock portion 21. The second width direction Z is along a width direction of the female lock portion 21 and the clearance portion 22. In addition, unless otherwise specified, each direction used in the following description will be described as a direction in a state where the first structural body 10 and the second structural body 20 are assembled to each other, that is, a direction in a state where the male lock portion 11 is inserted into the female lock portion 21 and the male lock portion 11 and the female lock portion 21 are engaged with each other.

In the height direction Y, the upper side corresponds to a side on which the first structural body 10 is located with respect to the second structural body 20 in a state where the first structural body 10 and the second structural body 20 are assembled to each other. In the height direction Y, the lower side corresponds to a side on which the second structural body 20 is located with respect to the first structural body 10 in a state where the first structural body 10 and the second structural body 20 are assembled to each other.

The male lock portion 11 is formed on the outer wall of the first structural body 10 and extends downward in the height direction Y. The male lock portion 11 includes an arm portion 11a and a locking projection 11b. The arm portion 11a is a plate-like portion extending downward in the height direction Y from the outer wall of the first structural body 10 and expanding along the height direction Y and the second width direction Z. The locking projection 11b is formed at the lower end of the arm portion 11a and protrudes in a direction from the female lock portion 21 toward the clearance portion 22.

As illustrated in FIGS. 1 and 2, the female lock portion 21 is formed as an opening portion in the second structural body 20. The female lock portion 21 is formed such that the male lock portion 11 can be inserted into the female lock portion 21. In the embodiment, the female lock portion 21 is formed as a substantially rectangular opening portion having the first width direction X as a lateral direction and the second width direction Z as a longitudinal direction when viewed from above. As illustrated in FIG. 3, an insertion port 21a for the male lock portion 11 in the female lock portion 21 has a tapered shape in which the opening width in the first width direction X decreases from the upper side to the lower side in the height direction Y. That is, the insertion port 21a of the female lock portion 21 has a tapered shape for guiding the male lock portion 11 from the outer wall portion of the female lock portion 21 toward the central opening when the male lock portion 11 is inserted.

The clearance portion 22 is a portion serving to allow for deflection of the female lock portion 21 which occurs when the male lock portion 11 is inserted into the female lock portion 21. The clearance portion 22 is formed as an opening portion in the second structural body 20, and is formed adjacent to the female lock portion 21 in the second structural body 20. In the embodiment, the shape of the clearance portion 22 viewed from the upper side in the height direction Y is substantially the same as the shape of the female lock portion 21 viewed from the upper side in the height direction Y. When the male lock portion 11 is inserted into the female lock portion 21, the wall portion separating the opening of the female lock portion 21 and the opening of the clearance portion 22 is deflected toward the clearance portion 22, so that the clearance portion 22 allows for the deflection of the female lock portion 21.

The restriction portion 23 is a portion serving to restrict insertion of the male lock portion 11 into the clearance portion 22. In the embodiment, the clearance portion 22 has an open end 22a adjacent to the insertion port 21a of the female lock portion 21, and the restriction portion 23 is formed to obstruct the open end of the clearance portion 22.

The restriction portion 23 of the embodiment is a belt-shaped member extending along the first width direction X. The restriction portion 23 of the embodiment is partially formed so as to obstruct a center portion of the open end 22a of the clearance portion 22. That is, the restriction portion 23 is formed so as to cross the center portion in the second width direction Z of the clearance portion 22 along the first width direction X.

In the embodiment, the restriction portion 23 includes a first straight portion 23a, a second straight portion 23b, and a bent portion 23c. The first straight portion 23a is a plate-like portion extending from a wall portion of the clearance portion 22 on the side of the female lock portion 21 in the first width direction X. The first straight portion 23a extends from the upper end of the wall portion of the clearance portion 22 on the side of the female lock portion 21. The second straight portion 23b is a plate-like portion extending from a wall portion of the clearance portion 22 on the side opposite to the female lock portion 21 in the first width direction X. In the embodiment, the upper end of the wall portion of the clearance portion 22 on the side opposite to the female lock portion 21 is located higher than the upper end of the wall portion of the clearance portion 22 on the side of the female lock portion 21, and the second straight portion 23b extends from the wall surface of the wall portion of the clearance portion 22 on the side opposite to the female lock portion 21. The bent portion 23c is a portion being bent provided between the first straight portion 23a and the second straight portion 23b.

Here, the bent portion 23c is formed so as to bend when the wall portion separating the opening of the female lock portion 21 and the opening of the clearance portion 22 is deflected toward the clearance portion 22, so that the stress applied to the restriction portion 23 is reduced. That is, the bent portion 23c of the restriction portion 23 is a portion for permitting the change in shape of the clearance portion 22 caused when the wall portion separating the opening of the female lock portion 21 and the opening of the clearance portion 22 is deflected toward the clearance portion 22.

The restriction portion 23 according to the embodiment is formed as a belt-shaped portion bent at the bent portion 23c so as to protrude upward. That is, the restriction portion 23 is formed in an inverted V shape having the bent portion 23c as a top as viewed in the second width direction Z.

The restriction portion 23 has an inclined surface 23s inclined toward the insertion port 21a of the female lock portion 21. In the embodiment, the upper surface of the first straight portion 23a serves as the inclined surface 23s. In the embodiment, the inclined surface 23s and the insertion port 21a form a continuous inclined surface. As illustrated in FIG. 4, when the male lock portion 11 is to be inserted into the clearance portion 22, the restriction portion 23 abuts on the male lock portion 11 to restrict the insertion of the male lock portion 11 into the clearance portion 22. Then, when the male lock portion 11 in this state is further moved downward, the male lock portion 11 is guided to the opening portion of the female lock portion 21 by the inclined surface 23s as indicated by an arrow Y1.

In the embodiment, the length of the first straight portion 23a in the first width direction X is set to be longer than the length of the second straight portion 23b in the first width direction X. For example, the length of the second straight portion 23b in the first width direction X is set to a length that makes it difficult for the distal end of the male lock portion 11 to enter between the bent portion 23c and the wall portion of the clearance portion 22 on the side opposite to the female lock portion 21. For example, by making the length of the first straight portion 23a in the first width direction X longer than the length of the second straight portion 23b in the first width direction X, the function of guiding the male lock portion 11 to the female lock portion 21 can be improved.

In the embodiment, the locking projection 11b of the male lock portion 11 has a substantially triangular cross section in the first width direction X. The protrusion degree of the locking projection 11b toward the clearance portion 22 in the first width direction X increases from the lower side toward the upper side, and the locking projection 11b has the lower side provided with an inclined surface 11ba and the upper side provided with a locking surface 11bb. In addition, the female lock portion 21 has a locked surface 21b on which the locking surface 11bb of the male lock portion 11 is to be locked, at the lower end of the wall portion separating the opening of the female lock portion 21 and the opening of the clearance portion 22. In the male lock portion 11, the length of the locking projection 11b in the first width direction X is set to be slightly longer than the length of the female lock portion 21 in the first width direction X, and the length of the arm portion 11a in the first width direction X is formed to be slightly shorter than the length of the female lock portion 21 in the first width direction X.

The male lock portion 11 is inserted so that the opening portion of the female lock portion 21 is widened in the first width direction X by the locking projection 11b. The lower end surface (locked surface 21b) of the wall portion separating the opening of the female lock portion 21 and the opening of the clearance portion 22 is formed so as to be located at a position corresponding to the upper side of the locking surface 11bb at an insertion completion position of the male lock portion 11, and therefore abuts on the locking surface 11bb when the male lock portion 11 reaches the insertion completion position. Here, the “insertion completion position” of the male lock portion 11 refers to the position of the male lock portion 11 when the male lock portion 11 and the female lock portion 21 are engaged with each other. After the locking projection 11b passes through the wall portion separating the opening of the female lock portion 21 and the opening of the clearance portion 22 and then the male lock portion 11 reaches the insertion completion position in the height direction Y, the deflection of the female lock portion 21 is eliminated and the locking surface 11bb and the locked surface 21b abut on each other. With such a configuration, the first structural body 10 is locked to the second structural body 20 by way of the male lock portion 11 and the female lock portion 21 engaged with each other.

As described above, the lock structure 100 according to the embodiment includes the male lock portion 11 which is formed in the first structural body 10, the female lock portion 21 which is formed in the second structural body 20 and into which the male lock portion 11 is insertable, the clearance portion 22 which is formed adjacent to the female lock portion 21 in the second structural body 20 and allows for the deflection of the female lock portion 21 which occurs when the male lock portion 11 is inserted into the female lock portion 21, and the restriction portion 23 which is formed in the second structural body 20 and restricts the insertion of the male lock portion 11 into the clearance portion 22.

The lock structure 100 according to the embodiment can restrict erroneous insertion of the male lock portion 11 into the clearance portion 22 by means of the restriction portion 23 at the time of assembling the first structural body 10 and the second structural body 20 to each other. With this configuration, for example, the work of assembling the first structural body 10 and the second structural body 20 to each other can be smoothly performed.

In addition, in the lock structure 100 according to the embodiment, the clearance portion 22 has the open end 22a adjacent to the insertion port 21a for the male lock portion 11 in the female lock portion 21, and the restriction portion 23 is formed so as to obstruct the open end 22a and has the inclined surface 23s inclined toward the insertion port 21a.

In the lock structure 100 according to the embodiment, since the restriction portion 23 has the inclined surface 23s inclined toward the insertion port 21a of the female lock portion 21, the male lock portion 11 can be guided to the insertion port 21a of the female lock portion 21 as the male lock portion 11 abuts on the inclined surface 23s. With this configuration, for example, the male lock portion 11 can be easily inserted into the female lock portion 21.

In addition, in the lock structure 100 according to the embodiment, the clearance portion 22 has the open end 22a adjacent to the insertion port 21a for the male lock portion 11 in the female lock portion 21, and the restriction portion 23 is partially formed so as to obstruct the center portion of the open end 22a.

In the lock structure 100 according to the embodiment, since the restriction portion 23 is partially formed so as to obstruct the center portion of the open end 22a, it is possible to restrict erroneous insertion of the male lock portion 11 into the clearance portion 22 by means of the restriction portion 23 while favorably maintaining a function of allowing for the deflection of the female lock portion 21 by the clearance portion 22, as compared with a case where the restriction portion 23 is formed so as to entirely close the open end 22a, for example. First modification

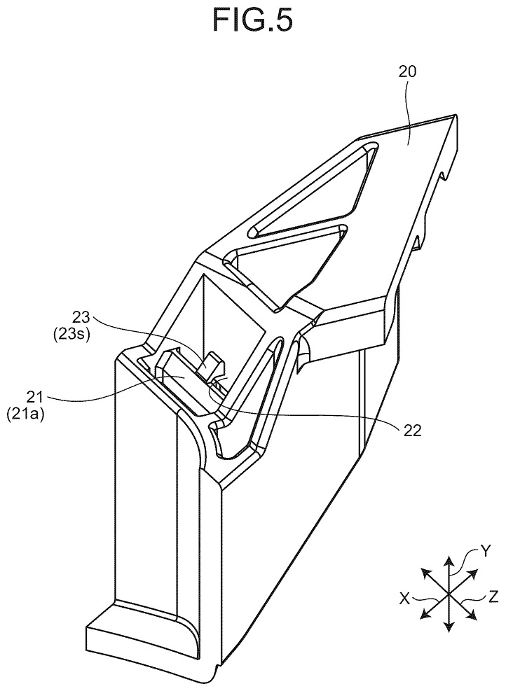

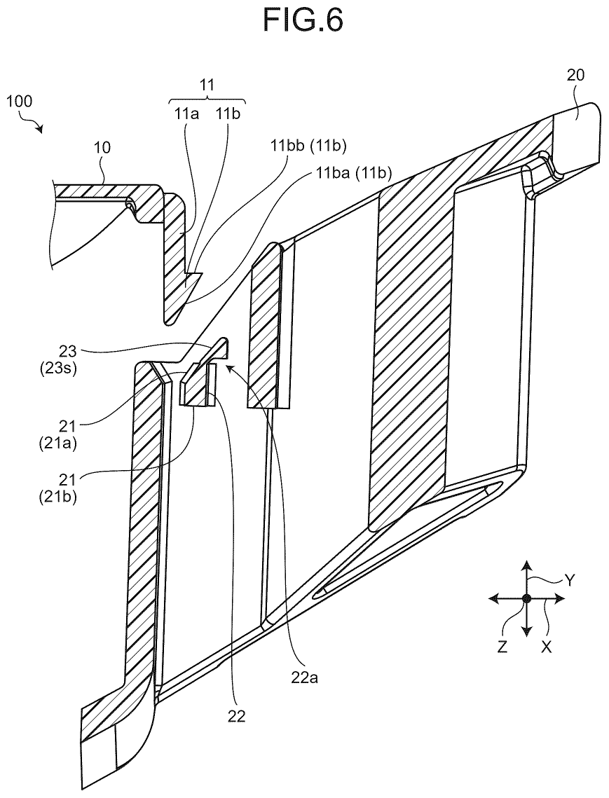

Next, a first modification of the embodiment will be described with reference to FIGS. 5 and 6. The first modification of the embodiment relates to a lock structure. FIG. 5 is a perspective view illustrating a female lock portion of the lock structure according to the first modification of the embodiment, and FIG. 6 is a cross-sectional view illustrating a cross section along a first direction of the lock structure according to the first modification of the embodiment.

A lock structure 100 according to the first modification is different from the lock structure 100 according to the above-described embodiment in that a restriction portion 23 is formed in a cantilever shape. Other configurations of the lock structure 100 according to the first modification are similar to those of the lock structure 100 according to the above-described embodiment.

In the first modification, as illustrated in FIG. 5, the restriction portion 23 protrudes from the wall portion separating the opening of the female lock portion 21 and the opening of the clearance portion 22 so as to obstruct the open end 22a of the clearance portion 22. An inclined surface 23s is formed on the upper surface of the restriction portion 23, and the inclined surface 23s and the insertion port 21a of the female lock portion 21 form a continuous inclined surface.

As illustrated in FIG. 6, the restriction portion 23 of the first modification has a thickness in the height direction Y increasing toward the side opposite to the female lock portion 21, and is formed in a triangular prism shape having a substantially triangular cross section in the first width direction X. For example, the length in the first width direction X between the restriction portion 23 and the wall portion of the clearance portion 22 on the side opposite to the female lock portion 21 is set to a length that allows the restriction portion 23 to restrict the insertion of the male lock portion 11 into the clearance portion 22. For example, the length in the first width direction X between the restriction portion 23 and the wall portion of the clearance portion 22 on the side opposite to the female lock portion 21 is set to be shorter than the length of the locking projection 11b in the first width direction X.

In the lock structure 100 according to the first modification, the restriction portion 23 is formed in a cantilever shape, and thus it is possible to prevent the restriction portion 23 from hindering the change in shape of the clearance portion 22 when the deflection of the female lock portion 21 is allowed by the clearance portion 22. Therefore, it is possible to restrict erroneous insertion of the male lock portion 11 into the clearance portion 22 by means of the restriction portion 23 while satisfactorily maintaining the function of allowing for the deflection of the female lock portion 21 by the clearance portion 22. In addition, by forming the restriction portion 23 in a triangular prism shape, the rigidity of the restriction portion 23 can be enhanced as compared with a case where the restriction portion 23 has a plate shape, for example. For example, this configuration causes the free end side of the restriction portion 23 to be deflected downward as the locking projection 11b abuts on the restriction portion 23, which can prevent the locking projection 11b from being fitted between the free end of the restriction portion 23 and the wall portion of the clearance portion 22 on the side opposite to the female lock portion 21. In addition, by forming the restriction portion 23 in a triangular prism shape, the strength of the restriction portion 23 can be improved.

### Second modification

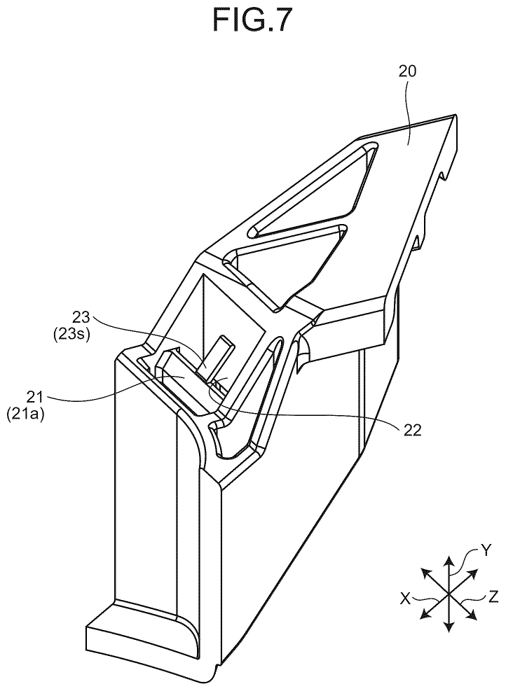

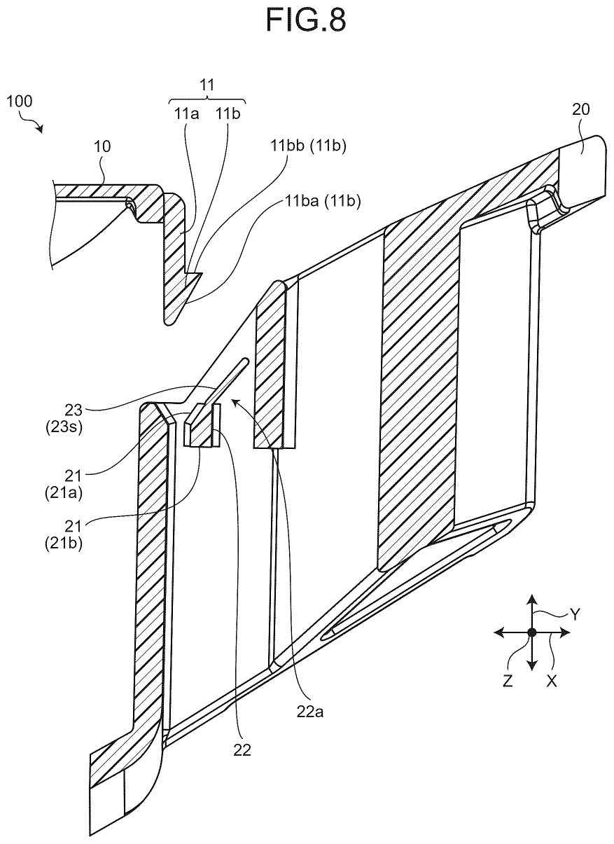

Next, a second modification of the embodiment will be described with reference to FIGS. 7 and 8. The second modification of the embodiment relates to a lock structure. FIG. 7 is a perspective view illustrating a female lock portion of the lock structure according to the second modification of the embodiment, and FIG. 8 is a cross-sectional view illustrating a cross section along a first direction of the lock structure according to the second modification of the embodiment.

A lock structure 100 according to the second modification is different from the lock structure 100 according to the above-described embodiment in that a plate-like restriction portion 23 is formed in a cantilever shape. Other configurations of the lock structure 100 according to the second modification are similar to those of the lock structure 100 according to the above-described embodiment.

In the second modification, as illustrated in FIG. 7, the restriction portion 23 protrudes from the wall portion separating the opening of the female lock portion 21 and the opening of the clearance portion 22 so as to obstruct the open end 22a of the clearance portion 22. The restriction portion 23 protrudes from the wall portion separating the opening of the female lock portion 21 and the opening of the clearance portion 22 in an inclined manner with the free end side facing upward. An inclined surface 23s is formed on the upper surface of the restriction portion 23, and the inclined surface 23s and the insertion port 21a of the female lock portion 21 form a continuous inclined surface.

As illustrated in FIG. 8, the restriction portion 23 is formed such that a gap is left between the free end of the restriction portion 23 and a wall portion of the clearance portion 22 on a side opposite to the female lock portion 21. For example, the gap is set to such a space that the restriction portion 23 does not abut on the wall portion of the clearance portion 22 on the side opposite to the female lock portion 21 when the wall portion separating the opening of the female lock portion 21 and the opening of the clearance portion 22 is deflected at the time of insertion of the male lock portion 11. In addition, the gap is set to, for example, such a space that the male lock portion 11 cannot pass between the restriction portion 23 and the wall portion of the clearance portion 22 on the side opposite to the female lock portion 21.

In the lock structure 100 according to the second modification, the restriction portion 23 is formed in a cantilever shape, and thus it is possible to prevent the restriction portion 23 from hindering the change in shape of the clearance portion 22 when the deflection of the female lock portion 21 is allowed by the clearance portion 22. Therefore, it is possible to restrict erroneous insertion of the male lock portion 11 into the clearance portion 22 by means of the restriction portion 23 while satisfactorily maintaining the function of allowing for the deflection of the female lock portion 21 by the clearance portion 22.

### Third modification

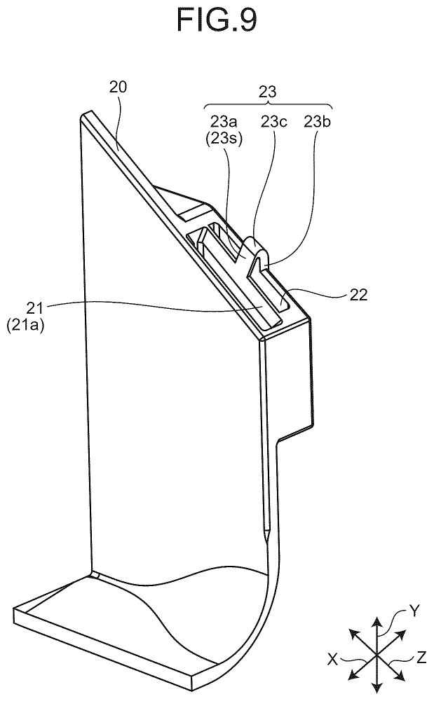

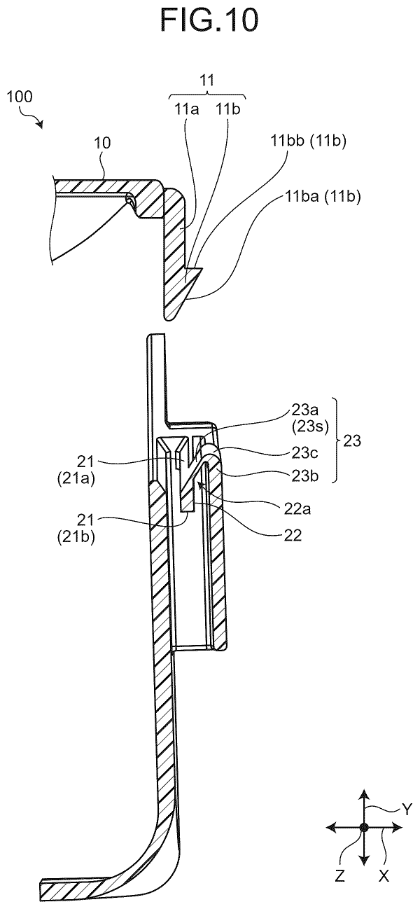

Next, a third modification of the embodiment will be described with reference to FIGS. 9 and 10. The third modification of the embodiment relates to a lock structure. FIG. 9 is a perspective view illustrating a female lock portion of the lock structure according to the third modification of the embodiment, and FIG. 10 is a cross-sectional view illustrating a cross section along a first direction of the lock structure according to the third modification of the embodiment.

A lock structure 100 according to the third modification is different from the lock structure 100 according to the above-described embodiment in that the first straight portion 23a of the restriction portion 23 extends from the upper end of the wall portion separating the opening of the female lock portion 21 and the opening of the clearance portion 22, and the second straight portion 23b of the restriction portion 23 extends from the upper end of the wall portion of the clearance portion 22 on the side opposite to the female lock portion 21. Another difference is that, as illustrated in FIG. 9, the position of the upper end of the female lock portion 21 and the position of the upper end of the clearance portion 22 are provided at substantially the same position in the height direction Y, and the upper end of the female lock portion 21 and the upper end of the clearance portion 22 are inclined downward from one side to the other side in the second width direction Z. Other configurations of the lock structure 100 according to the third modification are similar to those of the lock structure 100 according to the above-described embodiment.

In the third modification, as illustrated in FIG. 9, the restriction portion 23 is formed so as to connect the upper end of the wall portion separating the opening of the female lock portion 21 and the opening of the clearance portion 22 and the upper end of the wall portion of the clearance portion 22 on the side opposite to the female lock portion 21. As illustrated in FIG. 10, the first straight portion 23a extends while being inclined upward in the height direction Y from the upper end of the wall portion separating the opening of the female lock portion 21 and the opening of the clearance portion 22, and has an upper surface provided with an inclined surface 23s. The second straight portion 23b extends upward along the height direction Y from the upper end of the wall portion of the clearance portion 22 on the side opposite to the female lock portion 21. The bent portion 23c is a portion being bent provided between the first straight portion 23a and the second straight portion 23b, and formed so as to bend when the wall portion separating the opening of the female lock portion 21 and the opening of the clearance portion 22 is deflected toward the clearance portion 22, so that the stress applied to the restriction portion 23 is reduced.

In the lock structure 100 according to the third modification, the first straight portion 23a is formed to be inclined, and the second straight portion 23b is formed along the height direction, so that the function of guiding the male lock portion 11 abutting on the restriction portion 23 to the female lock portion 21 can be improved.

In the embodiment and the modifications described above, the description has been made on the assumption that the lock structure 100 is applied to a protector, but the invention is not limited thereto. For example, the lock structure 100 can also be applied to a housing of an electrical connection box or the like. Here, the electrical connection box is a housing that houses a circuit board or the like on which electronic components such as relays and fuses are mounted, which is a so-called relay box, a junction box, or the like.

The contents disclosed in the above embodiment and modifications can be appropriately combined and executed.

The lock structure according to the present embodiment has an effect of restricting erroneous insertion of the male lock into the clearance portion.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A lock structure comprising:
a male lock portion which is formed in a first structural body;
a female lock portion which is formed in a second structural body and into which the male lock portion is insertable;
a clearance portion which is formed adjacent to the female lock portion in the second structural body and allows for deflection of the female lock portion which occurs when the male lock portion is inserted into the female lock portion; and
a restriction portion which is formed in the second structural body and restricts insertion of the male lock portion into the clearance portion.

2. The lock structure according to claim 1, wherein
the clearance portion has an open end adjacent to an insertion port for the male lock portion in the female lock portion, and
the restriction portion is formed so as to obstruct the open end, and has an inclined surface inclined toward the insertion port.

3. The lock structure according to claim 1, wherein
the clearance portion has an open end adjacent to an insertion port for the male lock portion in the female lock portion, and
the restriction portion is partially formed so as to obstruct a center portion of the open end.

4. The lock structure according to claim 2, wherein
the clearance portion has an open end adjacent to an insertion port for the male lock portion in the female lock portion, and
the restriction portion is partially formed so as to obstruct a center portion of the open end.
